(19) United States
(12) Patent Application Publication
(10) Pub. No.: US 2008/0154404 A1
(43) Pub. Date: Jun. 26, 2008

(54) Disposable media player

(75) Inventors: Noam Kedem, Foster City, CA (US); Itzhak Pomerantz, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd.

(21) Appl. No.: 11/806,109

(22) Filed: May 30, 2007

Related U.S. Application Data
(60) Provisional application No. 60/871,839, filed on Dec. 26, 2006.

(51) Int. Cl. G06F 17/00

(52) U.S. Cl. 700/94

(57) ABSTRACT

A portable media player has controlling circuitry, a memory, and a non-rechargeable battery built into the media player's housing such that the battery cannot be removed, replaced, or detached without damaging the media player or otherwise rendering it inoperable. The portable media player may protect multimedia content, for example, by enabling the download of multimedia files or by playing any multimedia file according to a predefined rule. Multimedia files may be downloaded into the memory by using USB protocol and a connector that functions as a USB connector. An audio plug may be manipulated inside an output socket of the media player to turn the media player on and off and also to adjust the volume of the media player's output signal and to select a mode of operation, or any of these tasks may be exercised using control rings or touch switches.

### RELATED APPLICATIONS

This application claims priority under 35 U.S.C. § 119(e) to U.S. Provisional Application No. 60/871,839, filed Dec. 26, 2006, which is hereby incorporated by reference in its entirety.

This application is related to U.S. patent application Ser. No. ______ of the same inventor(s), which is entitled “A METHOD OF LIMITING THE PLAY BACK OF MULTIMEDIA CONTENT”, and filed on the same day as the present application. This application, also claiming priority to U.S. Provisional Application No. 60/871,839, is incorporated in its entirety as if fully set forth herein.

### BACKGROUND

The use and distribution of multimedia content continues to become more prevalent, and new media players are continually being developed. Accordingly, special terminology has become associated with this field. The term “multimedia” itself generally references the usage of multiple forms or formats of information content, such as audio, video, and animation, to transfer information and to entertain individual users or group audiences. The term “multimedia” also references the usage of electronic media by “media players,” which store and play back the multimedia content of multimedia files. The term “media player” is used to describe computer software or computerized devices that play back multimedia files. Some media players support more than one multimedia format, for example, audio and video. Media players that focus only on audio or video content are known as audio players and video players, respectively. Multimedia content is managed, that is, sold, delivered, stored, published, and so on, as electronic multimedia files from one site to another, for example, from a music seller to a music consumer. A media player converts a multimedia file into a stream of digital data and then into corresponding audio or video signals. These signals are then played through an output device, such as an earphone, a speaker or a display screen.

Traditionally, copyrighted multimedia content is protected by implementing licensing techniques that limit the manipulation and re-distribution of the content by end users. The licensing and protection of copyrighted multimedia content is sometime referred to as Digital Rights Management (DRM), a term used in reference to any technology of multimedia publishers or copyright owners that aids in controlling the access to and the usage of multimedia content. By way of example, a DRM license enables users to play back multimedia content but not to record or e-mail it. DRM licensing techniques sometimes frustrate multimedia content consumers. For example, such consumers may need to buy or rent and then implement supplementary hardware or software components that enforce DRM policies. Some copyrighted multimedia content can be relatively expensive.

Accordingly, it would be desirable to have a media player that protects copyrighted multimedia content while relieving multimedia content consumers from intricate copyright protecting measures. It would also be desirable to provide less expensive copyrighted multimedia content. It would further be desirable to have a portable media player that enabled the aforesaid features.

### SUMMARY

The present invention addresses the needs described above as disclosed herein. The following embodiments and aspects thereof are described and illustrated in conjunction with systems, tools, and methods, which are meant to be exemplary and illustrative but not limiting in scope.

In one embodiment of the invention, a portable media player is provided, which includes a controlling circuitry and a memory, the controlling circuitry and the memory being enclosed in a common housing. The portable media player also includes a non-rechargeable battery, which is built into the housing such that it cannot be removed, replaced, or detached from the portable media player without damaging the media player.

The memory may be a Non-Volatile Memory (NVM) device for storing one or more multimedia files and digital data that may include metadata related to multimedia files and an executable instruction code. In one embodiment the NVM device is a flash memory.

The controlling circuitry, which may be coupled to the memory, may be configured to download to and retrieve from the memory multimedia files and metadata. The controlling circuitry may be configured to limit writing to the memory to one time or to no more than a predetermined number of times. The controlling circuitry may be configured to prevent data in the memory from being erased or over written. The controlling circuitry may include a controller and a multimedia processor for converting multimedia files retrieved from the memory into a playable signal.

The portable media player may also include an output socket for outputting the playable signals, a volume control for adjusting the media player's output volume, and, optionally, a communication interface, which is configured to communicate with an external multimedia content source, for example, in order to receive therefrom one or more multimedia files and related metadata to be stored in the media player's memory.

The portable media player of the invention may protect copyrighted multimedia content, for example, by enabling the download of multimedia files according to a predefined rule. Such a rule may allow one or more multimedia files to be downloaded into the memory prior, during or after the fabrication of the media player. A rule may determine whether an end user can download multimedia files into the media player's memory using her/his own personal computer (PC), or these multimedia files can be downloaded, for example, at a point of sale (POS), which is the place where the end user can buy a selection of multimedia content and optionally the media player. Multimedia files may be downloaded into the media player's memory by using USB protocol and a communication interface that may include a USB connector.

The output socket may be adapted to be engaged by an audio plug and the output signal's volume may be controlled by the end user by pressing the audio plug into the output socket and rotating the plug while it engages a volume adjusting potentiometer. The term “potentiometer” references an electronic component which has a user-adjustable resistance. Often, a potentiometer is a three-terminal resistor with a central sliding contact. Alternatively, the volume of the audio signal is predetermined and cannot be changed by the end user.

In other embodiments of the present invention, the audio plug, while residing within the media player's output socket, is used to turn the media player on and off and to select a mode of operation, for example, “PLAY”, “REPLAY” or “STOP”.

In other embodiments of the present invention, modes of operation are selected by using one or more peripheral control rings to generate various control signals by rotating these rings about the media player's longitudinal axis, or by using one or more touch switches on the external surface of the media player's housing. “Touch switch” references a type of switch, which works using body capacitance. That is, when a person touches a touch switch, which inherently has a stray capacitance, its overall capacitance increases due to the person's added capacitance. Changes in the capacitance are converted into a corresponding electrical signal.

The disposable media player may have the form factor of a cylindrical C battery, M battery, MA battery or 9-Volt battery.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. It is intended that the embodiments disclosed herein are to be considered illustrative rather than restrictive. The disclosure, however, may better be understood with reference to the following detailed description when read with the accompanying figures, in which:

FIG. 1 is a block diagram of a portable media player in accordance with the present invention;

FIG. 2 depicts a standard battery;

FIG. 3 schematically illustrates a simplified internal layout of a portable media player in accordance with the present invention;

FIG. 4 is a general view of the media player of FIG. 3;

FIG. 5 illustrates a conventional audio plug;

FIG. 6 illustrates the audio plug of FIG. 5 inserted into the portable media player of FIG. 3;

FIG. 7 illustrates a portable media player connected to a file downloading station in accordance with the present invention;

FIG. 8 schematically illustrates a portable media player with a volume adjusting potentiometer and a power switch in its “open” state according to an embodiment of the present invention;

FIG. 9 schematically illustrates the portable media player of FIG. 8 with the volume adjusting potentiometer engaged with an audio plug and the power switch in its “close” state;

FIGS. 10A, 10B and 10C schematically illustrate a portable media player with a toggle power switch in three states, according to an embodiment of the present invention; and

FIG. 11 schematically illustrates a portable media player with two control rings and one touch switch according to yet another embodiment of the present invention.

It will be appreciated that for simplicity and clarity of illustration, elements shown in the figures are not necessarily drawn to scale. Further, where considered appropriate, reference numerals may be repeated among the figures to indicate like, corresponding or analogous elements.

### DETAILED DESCRIPTION

The invention summarized above and defined by the claims below will be better understood by referring to the present detailed description of embodiments of the invention. This description is not intended to limit the scope of claims but instead to provide examples of the invention.

A disposable portable media player is provided that manages multimedia content by limiting the play back time to the lifetime of a non-rechargeable battery, which is irremovably built into the media player's housing. In other words, multimedia content can be played back by the portable media player for a maximum time period determined by the lifetime of the media player's built-in battery.

FIG. 1 schematically illustrates the general layout and functionality of a portable media player 100 in accordance with the present invention. Media player 100 includes a memory 10 for storing one or more multimedia files and executable instruction code. Memory 10 may also contain metadata, which is related to a media content already stored in memory 10 or to a media content that is intended to be stored in memory 10. Metadata may include data relating, for example, to multimedia files' origin, byte size and formatting, and copyrights protection associated with stored, or yet to be stored, multimedia content or operational rules that are derived from such copyrights. Such operational rules may allow memory 10 to be written to once and read from more than once. Alternatively, such operational rules may allow memory 10 to be written to a predetermined maximum number of times.

Memory 10 may be a NVM device such as a flash memory. In general, a flash memory is a form of non-volatile memory (NVM) that can be electrically erased and reprogrammed. Flash memories are widely used, for example, with digital audio and video players, digital cameras and mobile phones. Also, flash memories can be found in Universal Serial Bus (USB) flash drives, which typically are used for general storage and transfer of data between computers.

Media player 100 also includes a controlling circuitry, generally shown at 124, which may include a controller, such as controller 12, which is operative to download and store multimedia files, executable instruction codes and related metadata, in memory 10. Controller 12 is also operative to retrieve from memory 10 digital data associated with stored multimedia files. Controller 12 may control other operational aspects of the media player as discussed below. Controller 12 may download multimedia files and metadata from an external multimedia content source 18 through communication path 120 and communication terminals 122. Controlling circuitry 124 may be configured to limit writing to memory 10 to one time or no more than a predetermined number of times. Controlling circuitry 124 may be configured to prevent data in memory 10 from being erased or over written.

The communication protocol used by controller 12 to download the multimedia files and the metadata from external multimedia content source 18 may be USB protocol, and communication terminals 122 may constitute a standard USB connector or a connector that has a different structure but functions like a USB connector.

Media player 100 also include a multimedia processor 13 for receiving the digital data retrieved from memory 10 by controller 12, decoding the received digital data and for converting decoded data into playable audio signals 15 or video signals 17. Multimedia processor 13 may utilize any digital audio decoding technology that has been devised, for example, by the Moving Picture Experts Group (MPEG), which is a working group that develops video and audio encoding standards. MP3, which is a more common name for MPEG-1 Audio Layer 3, is an exemplary popular digital audio encoding and lossy compression format and algorithm that significantly reduce the amount of digital data that is required to represent audio with an acceptable quality.

Depending on the application, multimedia processor 13 may also decode video signals, for example, by employing MPEG4, which is an expansion of MPEG-1 (the initial video and audio compression standard, which is used as the standard for Video CD), and DIVX (Digital Video Express), which is a specialized version of MPEG-4. Controller 12 and multimedia processor 13 are shown separately. However, controller 12 and multimedia processor 13 may collectively be regarded as the media player's controlling circuitry. Alternatively, multimedia processor 13 may be incorporated, embedded, or affiliated into controller 12.

Media player 100 may also include a signal amplifier, such as signal amplifier 14, for amplifying the audio and video signals before they are outputted from the media player. Depending on whether the media player is an audio player, a video player, or both, signal amplifier 14 may be an audio amplifier, or a video amplifier, or it may include an audio amplifier and a video amplifier.

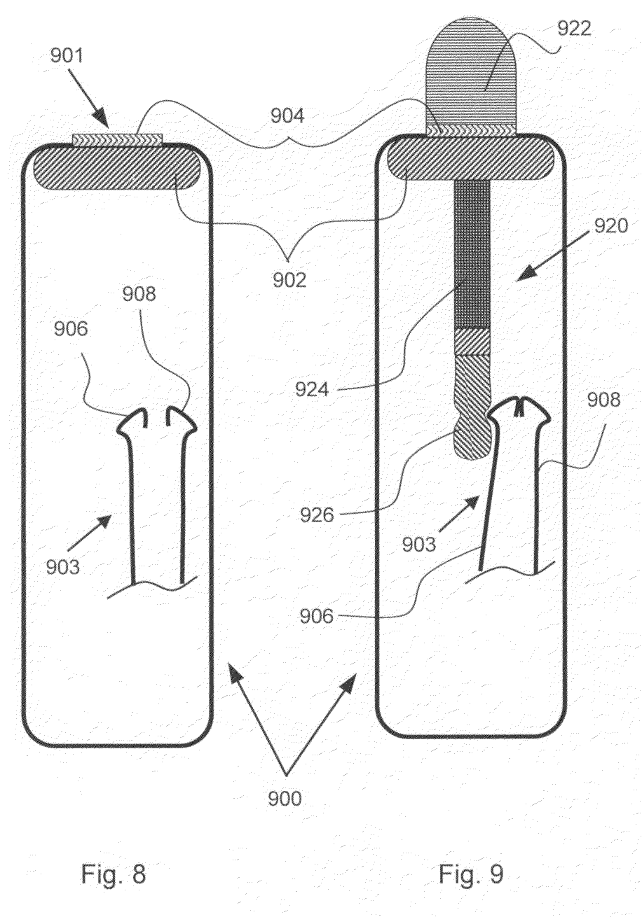

Media player 100 also includes an output socket 16 for outputting audio and video signals. Signal amplifier 14 may match the media player's output signals 15 and 17 to the input impedance of the speaker or earphone (not shown) connected to output socket 16. The magnitude of output signal 15 and 17 may be controlled by signal amplifier 14, which may be a Programmable Gain Amplifier (“PGA”). In general, PGA is an amplifier whose gain is programmable, which means that its gain value may be programmed to one of several optional values and thereafter reprogrammed to any other value from the optional values. The gain of signal amplifier 14 may be set by controller 12, for example, in response to a “VOLUME” control signal. An exemplary way to generate such a control signal is described in connection with FIGS. 8 and 9, discussed below.

Media player 100 also includes a non-rechargeable battery 11, which is irremovably built into the media player's housing (not shown in FIG. 1). In other words, battery 11 cannot be substituted, detached or removed from media player 100 without damaging the media player. After the charge of battery 11 is depleted, the multimedia files stored in memory 10 can no longer be played back (In alternative embodiments of the invention as discussed below, an external power source may be connected to the media player.)

### Switching a Media Player “On” and “Off”

Media player 100 may include a power switch (not shown in FIG. 1), which turns media player 100 on when a plug (not shown) is inserted into output socket 16 and turns media player 100 off when the plug is withdrawn or extracted from output socket 16. The power switch may be a “normally-open” switch whose actual state (“open” or “close”) depends on whether the plug is inserted in output socket 16. If output socket 16 is not occupied by the plug, the “open” state prevails, and the media player is in its “turned off” state. Otherwise, the inserted plug causes the normally-open switch to transition to the “close” state to thereby turn on the media player. Turning a media player on and off by using a normally-open switch is more fully described below in connection with FIGS. 8 and 9.

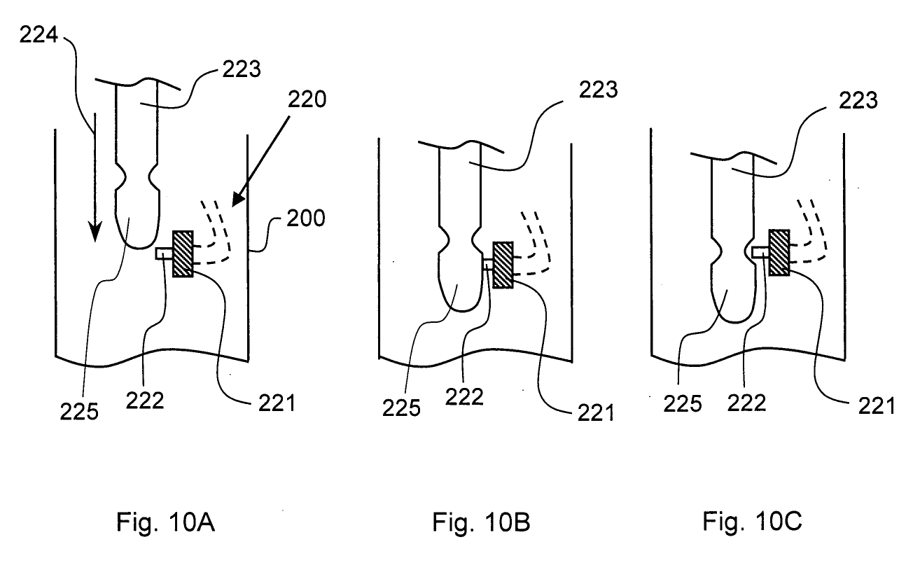

Alternatively, the power switch is a toggle switch. The term “toggle switch” references a class of electrical switches that use a mechanical lever, handle or rocking mechanism to actuate them, where each mechanical impulse or actuation causes a transition from whichever state (“open” or “close”) the switch is in to the alternate state. Turning a media player on and off by using a toggle switch is more fully described below in connection with FIGS. 10A, 10B and 10C.

After portable media player 100 is turned on, stored multimedia content may automatically be played back immediately, at the end of an initialization phase, or after a predetermined delay (for example after 5 seconds). Alternatively, after portable media player 100 is turned on it initially enters the “STOP” mode of operation. To operate media player 100, an end user may select any of the available modes of operation, such as “PLAY”, “STOP” and “REPLAY”, by using the plug in a way similar to using a computer joystick. A computer joystick is generally configured so that moving the stick left or right signals movement along the ‘X’ axis, and moving it forward or backwards signals movement along the ‘Y’ axis. Similarly, the portable media player may be configured so that moving the plug left signals selection of a first mode of operation (for example “PLAY”), moving the plug right signals selection of a second mode of operation (for example “STOP”), and so on. Selecting a mode of operation is more fully described below.

### Transducer 116 and Selection of a Mode of Operation

Media player 100 may also include a transducer 116, which is part of the media player's controlling circuitry and may be configured to output a control signal in response to a force on a plug that is inserted into output socket 16. Transducer 116 may include a torque transducer or one or more strain gauges. Generally, a strain gauge is a device used to measure deformation of an object. A common type of strain gauge consists of an insulating flexible backing which supports a metallic foil pattern. The gauge is attached to the object by a suitable adhesive, and as the object is deformed, the metallic foil is deformed, which causes its electrical resistance, and thus an electrical signal, to change in accordance with the metallic foil's deformation. Controller 12 may translate the electrical signal outputted by transducer 116 into a corresponding media player's mode of operation, as described below. Exemplary modes of operation include “PLAY”, “STOP” and “REPLAY”.

In order to enable transducer 116 to output an electrical signal that correlates to a given mode of operation, transducer 116 is mechanically coupled to output socket 16, through which transducer 116 may sense a force that is applied to a plug that is inserted into output socket 16. The mechanical coupling between transducer 116 and output socket 16 is symbolically shown as a dotted line 117. In other words, a plug may be inserted into output socket 16 or pushed sideways in output socket 16 in one or more directions to thereby employ a force, torque or strain vector on transducer 116 to cause output socket 16 to output a corresponding control signal. Transducer 116 may include several strain gauges in different spatial locations to cause transducer 116 to output a direction-dependent control signal. Controller 12, which may also function as a direction discriminator, may be supplied with the direction-dependent control signal fed from transducer 116 and, based on the direction-dependent control signal, determine which mode of operation is selected or requested.

### “PLAY” Mode

Assuming that the portable media player is currently in the “STOP” mode of operation and it is desired to switch it to the “PLAY” mode, a plug has to be pushed sideways in output socket 16 in the “PLAY” direction, to cause transducer 116 to generate and forward to controller 12 a control signal corresponding to the “PLAY” mode of operation. In response to the control signal, controller 12 streams digital data from memory 10 to multimedia processor 13 after it activates multimedia processor 13 and signal amplifier 14. Multimedia processor 13 concurrently decodes the streaming digital data, converts the decoded digital data into corresponding signal, which may be an audio or a video signal, and forwards the audio or video signal to signal amplifier 14. Signal amplifier 14 forwards audio signals 15 to an earphone or speaker, and video signals 17 to a display screen.

### “STOP” Mode

By way of example, in order to stop playing multimedia content, the plug is pushed sideways in the “STOP” direction, which may be the direction opposite the “PLAY” direction, to thereby cause transducer 116 to generate and forward to controller 12 a control signal corresponding to a “STOP” instruction. In response to the reception of such a control signal controller 12, stops the retrieval of digital data from storage array 10. Controller 12 may concurrently deactivate multimedia processor 13 and signal amplifier 14 to save battery power.

### “REPLAY” Mode

By way of example, in order to replay multimedia content, the plug is pushed sideways in output socket 16 in the “REPLAY” direction to cause transducer 116 to generate and forward to controller 12 a control signal corresponding to “REPLAY”. Controller 12 may assign a unique index to content items, which may be a song or a video clip, while they are played and store the assigned indices, for example, in memory 10. Alternatively, controller 12 may assign the unique indices at the time the content items are stored in memory 10.

If a control signal corresponding to the “REPLAY” mode of operation is received at controller 12, controller 12 aborts the current mode of operation (“PLAY” or “STOP”) and utilizes recorded index to find the location in memory 10 corresponding to the start instant of the preceding media content item.

After finding that location, controller 12 automatically resumes the “PLAY” mode of operation to replay the multimedia content item. To cause media player 100 to replay the two preceding content items, the plug is pushed twice in the “REPLAY” direction during a predefined time window to generate and forward to controller 12 two consecutive “REPLAY” control signals that will cause the media player to “skip” backwards two content items. If the three preceding content items are to be replayed, the plug has to be pushed three times in the “REPLAY” direction during the predefined time window, and so on. The counting of “one preceding content item,” “two preceding content items,” “three preceding content items,” etc. are relative to the currently played content item or alternatively relative to the content item that was last played.

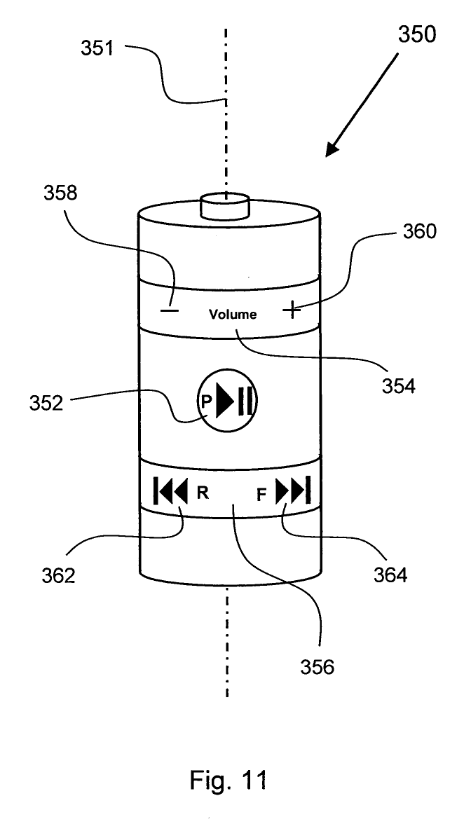

The modes of operation described above, and if desired additional or other modes, may be selected by using one or more peripheral control rings to generate various control signals by rotating the control rings about the media player's longitudinal axis, or by using one or more touch switches on the external surface of the media player's housing. A media player may include one or more control rings and one or more touch switches. Exemplary control rings and touch switch are shown in FIG. 11, discussed below.

FIG. 2 shows a standard battery 300, which has a cylindrical body 318, a positive contact 332 and a negative contact 325, which is opposite positive contact 332. A battery, such as battery 300, may have a form factor of a standard cylindrical C battery, “AA” battery or a “AAA” battery.

FIG. 3 illustrates cross-section of a portable media player 400 in accordance with the present invention. Media player 400 has a housing 27 that encloses a non-rechargeable battery 22, which has a longitudinal axis 46, memory and controller, which are collectively designated as 24, a multimedia processor 26, audio and/or video amplifier 28, a volume control 30, which may include a potentiometer, and an output socket 34, which has a longitudinal axis 48. Non-rechargeable battery 22 is built into housing 27 such that battery 22 cannot be substituted, removed or detached from media player 400 without damaging media player 400. Battery 22, memory and controller 24, multimedia processor 26, amplifier 28, and volume control 30, may be arranged in a different order from that shown in FIG. 3. According to an embodiment of the present invention, longitudinal axis 46 of battery 22 and longitudinal axis 48 of output socket 34 are coaxially aligned.

Housing 27 is made from or includes an electrically isolating material. Output socket 34, which is shown in FIG. 3 fastened to housing 27 with fastening nut 32, may be a standard earphone socket. Memory and controller 24 may function similarly to memory 10 and controller 12 of FIG. 1. Multimedia processor 26 may function similarly to multimedia processor 13 of FIG. 1. Audio and/or video amplifier 28 may function similarly to signal amplifier 14 of FIG. 1.

A media player of the present invention may include a communication interface, which is configured to receive multimedia files and related metadata that are to be stored in the media player's memory. In FIG. 3, media player 400 has a communication interface that includes three electrical contacts or terminals, designated 21, 23 and 25, at the surface of housing 27, for enabling controller 24 to download one or more multimedia files and metadata from an external multimedia content source (not shown in FIG. 3) to the media player's memory. Downloading the one or more multimedia files and the metadata from the external multimedia content source is executed by communicating with the external multimedia content source by using a suitable protocol, such as the USB protocol. The communication interface may include a USB connector. Alternatively, the communication interface includes a connector that functions as a standard USB connector but has a different structure. If the USB protocol is used, electrical contacts 21, 23 and 25, may serve as the USB's “D−”, “D+” and “Ground” (“Gnd”) terminals, respectively. The communication interface 21, 23 and 25, of portable media player 400 may be configured to receive power from an external power source to power the electronic circuitry of media player 400. Portable media player 400 may have an electronic sub-circuit to prevent the media player 400 from electrically damaging the external power source when the two devices are connected.

A portable media player of the present invention may have the form factor of a standard cylindrical C battery, AA battery, AAA battery, a standard 9-Volt battery, or other form factors. The housing of a portable media player of the present invention may have one or more dimensions smaller than 16 millimeters.

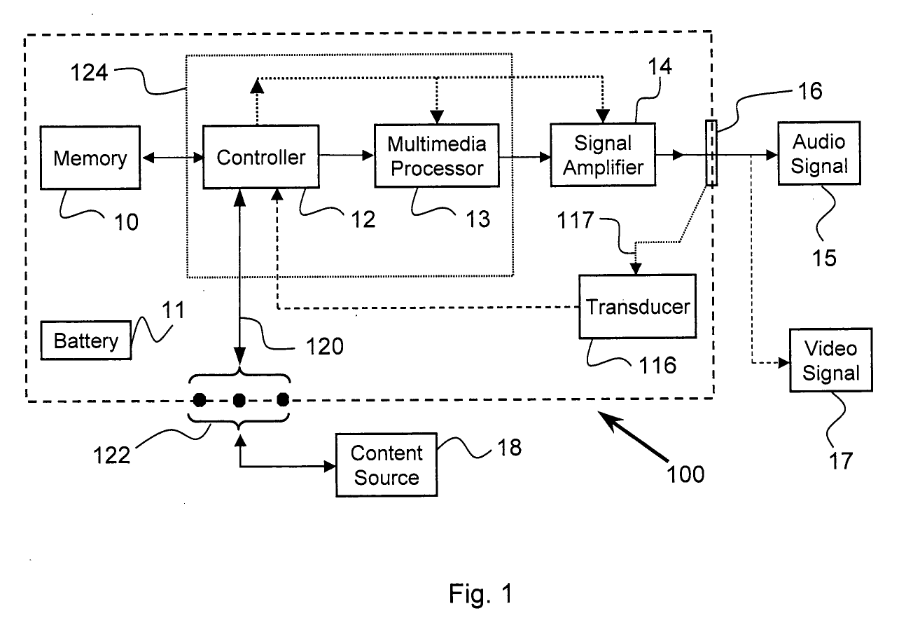

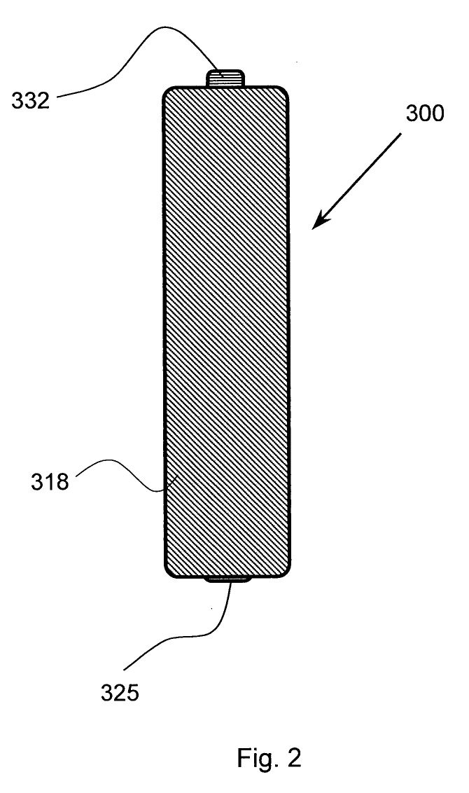

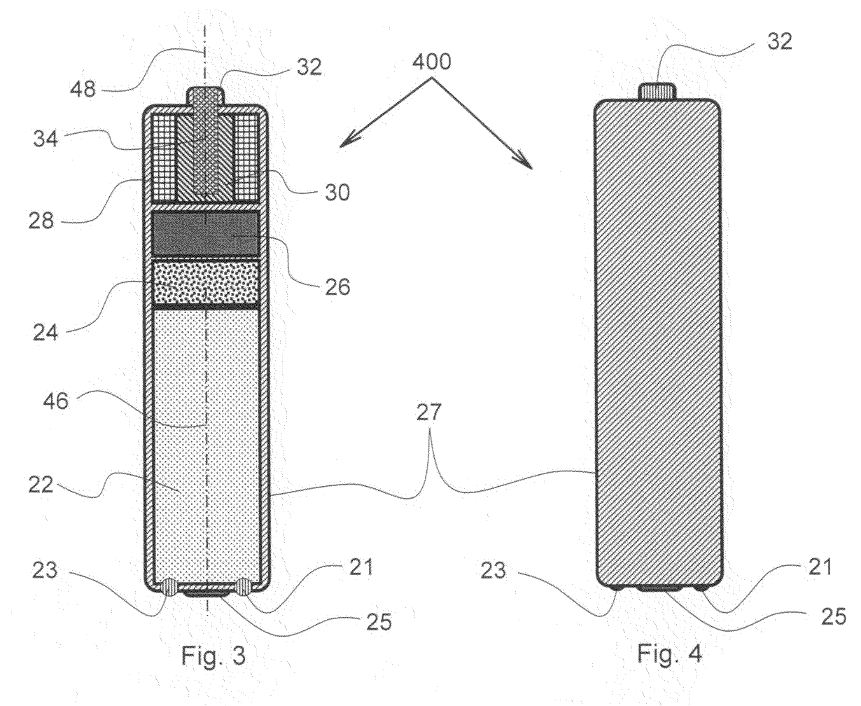

FIG. 4 shows a front view of portable media player 400 of FIG. 3, which resembles standard battery 300 of FIG. 2. The general appearance of body 18, fastening nut 32 and ground (Gnd) terminal 25 of media player 400 may respectively resemble body 318, positive contact 332 and negative contact 325 of standard battery 300 of FIG. 2.

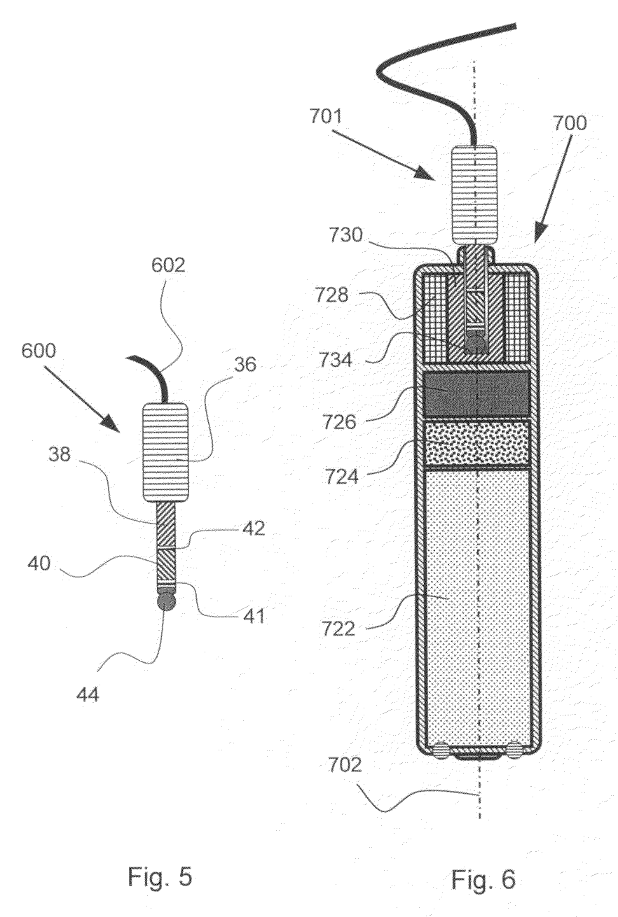

FIG. 5 illustrates a conventional earphone plug 600. Distal and innermost contact 44 functions as a Gnd contact. Distal gap 41 electrically isolates the left hand side audio channel 40 from the Gnd contact 44 and proximal gap 42 electrically isolates the left hand side audio channel 40 from the right hand side audio channel 38. Body 36, or at least the part adjacent right hand side audio channel 38, typically is made from or includes an isolating material. Audio cord 602 includes electrical wires for transferring the audio signals. Typically, an earphone plug, such as earphone plug 600, is inserted into an output socket and withdrawn from the output socket using its body 36.

FIG. 6 schematically illustrates a media player 700 with a plug 701 inserted into it in accordance with the present invention. In this embodiment, output socket 734, plug 701 and built-in battery 722 each has a longitudinal axis that coincides with a common longitudinal axis 702, which is the media player's longitudinal axis. Memory and controller 724, multimedia processor 726, signal amplifier 728 and volume control 730, which may be a potentiometer, may also have longitudinal axes that coincide with longitudinal axis 702. It may therefore be said that media player 700 as a whole is longitudinally oriented.

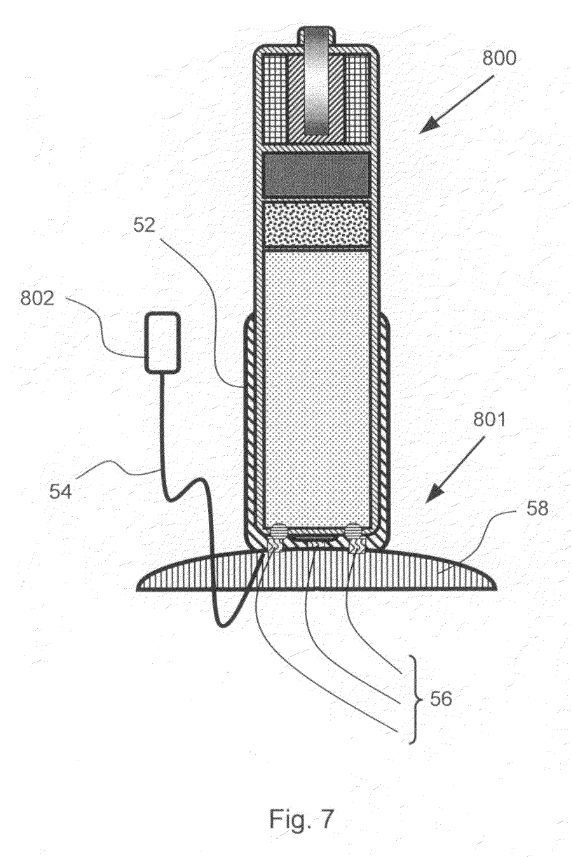

FIG. 7 illustrates a media player 800 that is connected to a file downloading station 801 in accordance with the present invention. In general, the file downloading station may be a simple cradle or it may be part of content-downloading kiosk. File downloading station 801 includes a receptacle 52 for receiving media player 800 and a base 58 for supporting file downloading station 801 upright, for example, on a desk. File downloading station 801 also includes a communication interface 56 that is adapted to be gravitationally engaged by the communication interface of media player 800. After engaging the communication interface of media player 800 with communication interface 56, the controller (not shown in FIG. 7) of media player 800, which may function like controller 12 of FIG. 1, may exchange data with and download multimedia files from an external multimedia content source, such as USB host 802, which is electrically connected to communication interface 56 via communication cable 54. Multimedia files downloaded by the controller of media player 800 may be transferred by the controller to a memory, such as memory 10 of FIG. 1. Communication interface 56 may be configured to provide power, through the communication interface of media player 800, from an external power source (not shown in FIG. 7).

FIG. 8 schematically illustrates a media player 900 with a volume adjusting potentiometer 901 as an exemplary volume control, and a “normally-open” power switch 903 in an “open” state according to an embodiment of the present invention. In this embodiment, the volume adjusting potentiometer 901 has a flattened body 902 with an electrical resistance that can be adjusted by a central sliding contact (not shown). Volume adjusting potentiometer 901 also has a rotatable adjustment disc 904 that can be rotated about an axial pin (not shown) that is mechanically coupled to the potentiometer's central sliding contact. Rotation of adjustment disc 904 about the axial pin causes the central sliding contact to slide and change the electrical resistance of potentiometer 901. The upper part of adjustment disc 904 is made from or include a material with high coefficient of friction, such as rubber. Adjusting the potentiometer's resistance, and thereby the magnitude of the media player's outputted audio signal, may be performed by rotating adjustment disc 904 while depressing its upper side downwards with plug 922.

In this embodiment, turning media player 900 on and off is performed by closing and opening, respectively, an electrical path, which includes spring contacts 906 and 908 of power switch 903, the media player's built-in battery (not shown) and the electronic circuitry (not shown). As no plug is inserted into the output socket of media player 900, spring contacts 906 and 908 are shown in FIG. 8 in an “open” state, for which reason switch 903 is said to be a “normally-open” switch. In the “open” state the media player's built-in battery is disconnected and media player 900 is turned off. The output socket is omitted from FIG. 8, as FIG. 8 focuses on the volume control and on the power switch.

FIG. 9 illustrates the media player 900 of FIG. 8 with a plug 920 inserted into the output socket (not shown). The output socket is omitted from FIG. 9, as FIG. 9 focuses on the volume adjusting potentiometer and on the switch. Plug 920 includes a body 922 for enabling insertion and withdrawal of plug 920 to and from media player 900. Plug 920 also includes a male member 924 with a rounded distal tip 926. The tip 926 of the plug 920 forces spring contact 906 to bend towards and touch the opposite spring contact 908, to thereby connect the media player's battery (not shown in FIG. 9) to the electronic circuitry. Turning off media player 900 is performed by cancelling that force by withdrawing the plug tip 926. Adjusting the amplitude of the audio signal may be performed by depressing the lower side of the plug's body 922 against the adjusting disc 904 and rotating the plug's body 922 clockwise or counter clockwise. Alternatively, adjusting the amplitude of the audio signal may be performed by using a peripheral “volume” control ring that generates a volume control signal by rotating the volume ring clockwise and counter clockwise about the media player's longitudinal axis. An exemplary volume control ring is shown in FIG. 11, discussed below. As another alternative, the amplitude of the media player's audio signal may be fixed, in which case volume adjusting potentiometer 901, or the volume control ring is omitted.

FIGS. 10A, 10B and 10C schematically illustrate a toggle power switch 220 in accordance with the present invention. FIG. 10A illustrates the state of toggle power switch 220 before it is actuated by a plug male member 223. Toggle switch 220 includes the switch body 221 with internal switch mechanism, an actuator 222 coupled to the switch mechanism and retractable into switch body 221, and electrical wires, which are shown in broken lines. Toggle switch 220 is shown in FIG. 10A in its “open” state.

To turn on media player 200 the plug male member 223 has to be inserted in insertion direction 224 such that when the plug's rounded tip 225 moves pass toggle switch 220, it causes actuator 222 to move and retract linearly into switch body 221 to thereby cause toggle switch 220 to switch from the initial, or normally “open”, state to the alternate “close” state. Toggle switch 220 is shown in FIG. 10B in its “close” state because tip 225 Causes actuator 222 to retract into switch body 221. In FIG. 10C, plug male member 223 is shown fully inserted into the output socket of media player 200 and the actuator 222 is shown fully protruding from switch body 221, ready to be retracted again by tip 225 when the plug's male member 223 is moved pass actuator 222 in the withdrawal direction, which the direction opposite insertion direction 224.

FIG. 11 shows an embodiment in which media player 350 is operated using a “PLAY/STOP” touch switch, designated as 352, and “VOLUME” and “REPLAY/FORWARD” peripheral control rings, designated, respectively, as 354 and 356. “PLAY/STOP” touch switch 352 may reside on, or it may be part of, the peripheral surface of media player 350. Each of, or both, “VOLUME” control ring 354 and “REPLAY/FORWARD” control ring may be rotated about the media player's longitudinal axis 351 to generate a corresponding control signal.

After turning on media player 350, for example in the way described above, multimedia content, which is stored in the memory (not shown in FIG. 11) of media player 350, may be played back by touching “PLAY/STOP” touch switch 352 once. Touching “PLAY/STOP” touch switch 352 again stops the play back. The volume of played back multimedia content may be decreased by rotating “VOLUME” ring 354 clockwise, in the “−” direction, shown at 358, or increased by rotating ring 354 counter clockwise, in the “+” direction, shown at 360.

“Volume” control ring 354, which is shown in FIG. 11 in its initial position, may be used in several ways. For example, the volume is increased and decreased stepwise. That is, in order to increase the volume to a desired level, control ring 354 is momentarily rotated counter clockwise until it reaches a mechanical stoppage, to thereby increase the volume by one step, and then released. Releasing control ring 354 may cause it to return to its initial position because of a force that is applied to it, for example by a spring (not shown). If a higher volume is required at that point, control ring 354 is to be rotated counter clockwise one more time and released, and the procedure is to be repeated until the desired volume is reached. Decreasing the volume is executed likewise, but control ring 354 is rotated clockwise one or more times to reach a desired volume. Alternatively, control ring 354 is rotated in a desired direction and, depending on that direction, the volume is increased or decreased continuously so long as control ring 354 is retained at the corresponding stoppage point.

Alternatively, rotating control rings 354 and 356 are replaced with two touch switches, one for decreasing the volume, which corresponds to “−” 358, and the other for increasing the volume, which corresponds to “+” 360. The volume can be increased and decreased stepwise or continuously by respectively touching a touch switch one or more times or continuously. “REPLAY/FORWARD” peripheral control ring 356 is operated in a similar way as “Volume” control ring 354, except that “−” 358 and “+” 360 are replaced with “REPLAY” and “FORWARD”, respectively shown at 362 and 364, and the control signals, which are resulted from control ring 356, change accordingly. A control ring, such as “VOLUME” control ring 354, may be a closed ring or an open ring.

Control signals associated with touch switch 352 and with control rings 354 and 356 may be interpreted by a controller, such as controller 12 of FIG. 1, to a corresponding command (“PLAY”, STOP”, “Volume −”, “Volume +”, “REPLAY” or “FORWARD”).

Another embodiment of the invention is a method of limiting the play back of multimedia content in a memory of a portable media player. The method includes providing a non-rechargeable battery as a power source for the portable media player and enclosing the battery within a housing of the media player such that the battery cannot be removed without damaging the portable media player. The method may further include a step of providing a communication interface to receive multimedia content in the form of multimedia files and related metadata.

A media player may be fabricated or assembled with an empty memory, that is, with a memory that does not contain multimedia content, and multimedia content may later be downloaded into the media player's memory, for example, at a point of sale (POS) using the communication interface. Alternatively, the media player's memory may be initially provided with multimedia content at the time the media player is fabricated or assembled and additional or replacement multimedia content may later be downloaded into the media player's memory by using the using the communication interface. If, however, the media player is fabricated without a communication interface, multimedia content with which the memory is provided can be read, but no additional or replacement multimedia content can be downloaded into the memory.

The method may further include a step of providing controlling circuitry that allows writing into the media player's memory only once. However, the controlling circuitry may be configured to allow writing into the media player's memory more than once and up to a predetermined number of times.

The present invention may, of course, be carried out in different ways than those herein set forth without departing from the spirit and characteristics of the invention. The embodiments shown and described herein are, therefore, to be considered in all respects as illustrative and not restrictive, and all changes coming within the meaning and equivalency range of the appended claims are intended to be embraced therein.

What we claim:

1. A portable media player comprising:
a) a memory;
b) controlling circuitry;
c) a housing enclosing said memory and said controlling circuitry; and
d) a non-rechargeable battery built into said housing such that said battery cannot be removed without damaging the portable media player.

2. The portable media player according to claim 1, further comprising:
e) an output socket; and
f) a volume control,
wherein said volume control is manipulated by a plug inserted into said output socket.

3. The portable media player according to claim 2, wherein a longitudinal axis of said output socket and a longitudinal axis of said battery are coaxially aligned.

4. The portable media player according to claim 2, wherein said controlling circuitry includes a transducer configured to output a control signal in response to a force on a plug inserted into said output socket.

5. The portable media player according to claim 1, further comprising:
e) an output socket,
wherein an insertion of a plug into said output socket turns the media player on.

6. The portable media player according to claim 1, further comprising:
e) a peripheral volume control ring,
wherein the volume is manipulated by rotating said peripheral volume control ring about a longitudinal axis of the media player.

7. The portable media player according to claim 1, further comprising:
e) one or more peripheral control rings, each control ring associated with a different mode or modes of operation,
wherein a mode of operation is selected by rotating the associated peripheral control ring about a longitudinal axis of the media player.

8. The portable media player according to claim 1, further comprising:
e) one or more touch switches on the external surface of said housing, each touch switch associated with a different mode or modes of operation,
wherein a mode of operation is selected by touching the associated touch switch.

9. The portable media player according to claim 1, further comprising:
e) a communication interface configured to receive multimedia files to be stored in said memory.

10. The media player according to claim 9, wherein said communication interface includes a universal serial bus (USB) connector.

11. The media player according to claim 9, wherein said communication interface is configured to receive power from an external source for said controlling circuitry.

12. The media player according to claim 9, wherein said communication interface is configured to engage a communication interface of a file downloading station.

13. The media player according to claim 1, wherein said housing has one dimension smaller than 16 millimeters.

14. The media player according to claim 1, wherein said housing has at least two dimensions smaller than 16 millimeters.

15. The media player according to claim 1, wherein said housing has the form factor of a standard AA battery.

16. The media player according to claim 1, wherein said housing has the form factor of a standard AA battery.

17. The media player according to claim 1, wherein said housing has the form factor of a cylindrical C battery.

18. The media player according to claim 1, wherein said housing has the form factor of a standard 9-volt battery.

19. The media player according to claim 1, wherein the memory is a flash memory.

20. The media player according to claim 1, wherein said controlling circuitry is configured to limit writing to said memory to one time.

21. The media player according to claim 1, wherein said controlling circuitry is configured to prevent data in said memory from being erased or over written.

22. The media player according to claim 1, wherein said controlling circuitry is configured to allow writing to said memory no more than a predetermined number of times.
